(19) United States
(12) Patent Application Publication
(10) Pub. No.: US 2026/0218651 A1
(43) Pub. Date: Jul. 30, 2026

(54) A SYSTEM AND A METHOD FOR MIXING A RECIRCULATED EXHAUST GAS STREAM WITH AIR TO OBTAIN A GAS MIXTURE TO BE FED TO A GAS TURBINE

(71) Applicant: NUOVO PIGNONE TECNOLOGIE -S.R.L., Florence (IT)

(72) Inventors: Ravindra Gopaldas DEVI, Maharashtra (IN); Andrea CARBONARI, Porto Recanati (IT); Mirko LUPATTELLI, Florence, Firenze (IT); Vittorio MICHELASSI, Florence, Firenze (IT); Stefano GIMMI, Pontassieve (IT); Flavio ROMAGNOLI, Loreto, Ancona (IT)

(21) Appl. No.: 19/157,896

(22) PCT Filed: Feb. 22, 2024
(86) PCT No.: PCT/EP2024/025087

§ 371 Date: Aug. 19, 2025

(30) Foreign Application Priority Data
Feb. 24, 2023 (IT) 102023000003210

(51) Int. Cl. F02C 3/34

(52) U.S. Cl. CPC F02C 3/34

(57) ABSTRACT

A system for mixing a recirculated exhaust gas stream from a gas turbine with fresh air to obtain a gas mixture to be fed to a compressor of the gas turbine comprising a mixing chamber, the mixing chamber being provided with: one recirculated exhaust gas stream inlet opening, on a first side of the mixing chamber, at least one fresh air stream inlet opening, on a second side of the mixing chamber, said second side being intersecting to said first side, and a mixed gas stream outlet opening, on a third side of the mixing chamber, said third side being opposed to said first side, a recirculated exhaust gas stream duct being connected to said recirculated exhaust gas stream inlet opening and a mixed gas stream outlet duct being connected to said mixed gas stream outlet opening.

### TECHNICAL FIELD

The present disclosure concerns a system and a method for mixing a recirculated exhaust gas stream from a gas turbine with fresh air to obtain a gas mixture to be fed to a compressor of the gas turbine. Embodiments disclosed herein specifically concern systems for mixing a recirculated exhaust gas stream from a gas turbine with fresh air that include high-efficiency filters to separate a mixing chamber from a fresh air intake section including fresh air ventilation fans, so to ensure zero ingestion by ventilation fans of CO₂ from the recirculated exhaust gas stream. Embodiments disclosed herein also specifically concern systems and methods for mixing a recirculated exhaust gas stream from a gas turbine with fresh air that comprise a recirculated exhaust gas stream duct, the cross section of said recirculated exhaust gas stream duct being configured to allow the velocity of the recirculated exhaust gas stream to be substantially equal to the velocity of the mixed gas stream downstream the system. Additionally, embodiments disclosed herein also specifically concern systems for mixing a recirculated exhaust gas stream from a gas turbine with fresh air that comprise a bent portion upstream a mixing chamber, the bent portion comprising at least one splitter, to prevent flow separation and flow fluctuations downstream, minimal pressure loss and significant reductions in flow-induced vibrations.

### BACKGROUND ART

The recirculation of exhaust gases is a technology that can, in principle, be used for a wide variety of purposes in gas turbines. For example, for the control of the emissions, for the reduction of the exhaust gas volume, for the carbon dioxide separation, etc.

During the recirculation of exhaust gases in a gas turbine, a substantial proportion of the exhaust gas is branched off from the entire exhaust gas stream and is normally fed back, after cooling and cleaning, to the inlet mass stream of the turbine or to the compressor of the turbine, wherein the recirculated exhaust gas stream is mixed with fresh air, and this mixture is subsequently fed to the compressor.

For example, EP1484102 describes a process in which exhaust gas is branched off at the outlet of the turbine, optionally conducted via a condenser, and subsequently admixed with an inlet air stream of the compressor. According to this document, the separation of carbon dioxide from the recirculated exhaust gas stream takes place either before the compressed gases enter the combustion chamber, immediately before or in an intermediate stage of the compressor.

For an efficient and unproblematic supply of the air flow of the recirculated exhaust gases, it is important that the recirculated exhaust gases are optimally mixed with the freshly supplied air. Good mixing of the recirculated exhaust gases with the intake air is necessary, particularly with a high proportion of recirculation (typically greater than 30%). In fact, since the residual oxygen content of the exhaust gases is too low to allow complete combustion in the power plant, insufficient mixing with the intake air leads locally to incomplete combustion, to high carbon monoxide and UHC (unburned hydrocarbon) emissions and to locally high combustion temperatures in the area with undiluted fresh air with potentially high NOx emissions. Since the recirculated exhaust gases are typically not cooled to ambient temperature, but are 10-20° C. warmer than the fresh intake air, insufficient mixing in gas turbines also leads to cold and warm streaks in the compressor intake air. These reduce the surge limit and impair operational safety. In order to minimize the power and efficiency losses due to recirculation, also to minimize the pressure loss when admixing the recirculated exhaust gases or by fittings for admixing. Accordingly, special devices must be installed in the intake air path to ensure an optimal mixture between the fresh air and the exhaust gas.

For example, U.S. Pat. No. 8,443,584B2 discloses a system that may recirculate a portion of the exhaust gas stream of at least one turbomachine, where the exhaust gas stream is mixed with fresh air and re-enter the turbomachine without affecting reliability and availability of the unit. An embodiment disclosed in U.S. Pat. No. 8,443,584B2 provides an inlet system for an exhaust gas recirculation system. This inlet system may take a variety of forms and may optimize the direction that the portion of the recirculated exhaust stream flows within the inlet system. In particular, the inlet system may be located at the outlet portion of at least one exhaust gas recirculation duct downstream of a silencer section, in order to reduce the likelihood of flow distortions developing when the recirculated exhaust gas stream and the airstream are mixed to create an inlet fluid to be fed to a compressor of a gas turbine. In particular, according to an embodiment of U.S. Pat. No. 8,443,584B2, an exhaust gas recirculation duct is disclosed comprising a plurality of movable vanes. A user may adjust the position of the movable vanes to an optimized angle for directing the path of the exhaust stream.

In order to prevent or minimize additional installations and pressure losses, modified silencers are proposed according to WO2010142473 for admixing the recirculated exhaust gases. Mufflers are large-volume components that go through the entire flow cross section of the filter house or intake tract and serve to reduce noise emissions in the intake tract. The recirculated air can be routed through its interior and mixed with the fresh air via its surface, which is designed as a perforated plate. Furthermore, at least part of the recirculated exhaust gases can be admixed through the downstream trailing edge of the silencers in the direction of the main flow. This means that the kinetic energy of the mixed exhaust gases is not destroyed by turbulence. Furthermore, the effective pressure loss can be reduced by introducing the exhaust gases through the trailing edge of the silencer. Introducing the recirculated exhaust gases via the silencers reduces their effective pressure loss and minimizes the pressure loss for introducing the recirculated exhaust gases through the use of these large-volume components. In addition, a quasi-ideal mixing with fresh air is realized.

U.S. Pat. No. 9,453,460 B2 discloses an intake section upstream of the inlet of a compressor of a gas turbine unit with fluegas recirculation. The intake section includes at least one section with a flow path defined by sidewalls in which the fresh airflow of the intake air is flowing along a principal airflow direction, including at least one mixing duct, in particular a plurality of mixing ducts, extending into the flow path from at least one sidewall. The mixing duct includes an intake at the at least one sidewall for receiving recirculated fluegas, as well as including at least one outlet opening distanced from said sidewall for blowing recirculated fluegas out of the mixing duct into the airflow. However, the mixing ducts form an-obstruction to the air flow path, with consequent pressure losses.

Nevertheless, the current solutions neither ensure zero ingestion by ventilation fans of CO₂ from the recirculated exhaust gas stream nor prevent flow separation and flow fluctuations downstream. Additionally, the current solutions are affected by pressure loss and flow-induced vibrations.

Accordingly, an improved system for mixing a recirculated exhaust gas stream from a gas turbine with fresh air to obtain a gas mixture to be fed to a compressor of the gas turbine, to address the issues of ingestion by ventilation fans of CO₂, flow separation, flow fluctuations, high pressure losses and flow-induced vibrations of the systems of the current art would be beneficial and would be welcomed in the technology. Additionally, the proposed system does not generate flow distortions downstream. More in general, it would be desirable to provide systems adapted to more efficiently address problems entailed by the systems for mixing a recirculated exhaust gas stream from a gas turbine with fresh air to obtain a gas mixture to be fed to a gas turbine.

### SUMMARY

In one aspect, the subject matter disclosed herein is directed to a system for mixing a recirculated exhaust gas stream from a gas turbine with fresh air to obtain a gas mixture to be fed to a compressor of the gas turbine, wherein up to 80% of the exhaust gas from the gas turbine is recirculated while keeping the flow distortions at compressor inlet within accepted limits. The system comprises a mixing chamber wherein recirculated exhaust gas is mixed with fresh air to obtain a mixed gas stream. In particular, the recirculated exhaust gas stream inlet opening is arranged in line with the gas mixture stream outlet opening and the fresh air stream inlet opening is arranged in an intersecting direction, preferably an orthogonal direction. As a result, the recirculated exhaust gas stream flows inside the mixing chamber with a linear path, while the air flows towards the core of the exhaust gas stream in a cross-streamwise direction over a length that is equal to the height of the mixing chamber, with a consequent effective mixing with low mixing losses.

In another aspect, the subject matter disclosed herein concerns a system for mixing a recirculated exhaust gas stream from a gas turbine with fresh air wherein pressure, temperature and flow angle distortion consequent to the mixing of the recirculated exhaust gas stream and fresh air are maintained within set limits. Additionally, the system prevent vibrations and noise at a silencer downstream.

In another aspect, the subject matter disclosed herein concerns a system for mixing a recirculated exhaust gas stream from a gas turbine with fresh air to obtain a gas mixture to be fed to a compressor of the gas turbine, wherein the system has low weight and allows for a limited height of the recirculated exhaust gas duct.

A further aspect of the present disclosure is a system for mixing a recirculated exhaust gas stream from a gas turbine with fresh air allowing for good mixing and low pressure loss.

Another aspect of the present disclosure is a low energy system for mixing a recirculated exhaust gas stream from a gas turbine with fresh air. In fact, the recirculated exhaust gas stream inlet opening being arranged in line with the gas mixture stream outlet opening and the fresh air stream inlet opening being arranged in an intersecting direction, preferably an orthogonal direction allow for a very large volume of the mixing chamber and cross section areas of the air inlet opening, the air flowing towards the core of the exhaust gas stream in a cross-streamwise direction over a length that is equal to the height of the mixing chamber 11, with the result that the velocity of the fresh air stream is significantly lower than that of the mixture flow, with a consequent effective mixing with low mixing losses.

An additional aspect of the present disclosure is directed to a method for mixing a recirculated exhaust gas stream from a gas turbine with fresh air to obtain a gas mixture to be fed to a compressor of the gas turbine, wherein the velocity of the recirculated exhaust gas stream is equal to the velocity of the mixed gas stream downstream the system, wherein up to 80% of the exhaust gas from the gas turbine can be recirculated while keeping the flow distortions at compressor inlet within accepted limits.

In another aspect, the subject matter disclosed herein concerns a method for mixing a recirculated exhaust gas stream from a gas turbine with fresh air to obtain a gas mixture to be fed to a compressor of the gas turbine, wherein the exhaust gas recirculation percentage can be regulated so as to allow the velocity of the recirculated exhaust gas at the recirculated exhaust gas stream inlet opening to be from 70 to 130% the velocity of the mixed gas stream inside the mixed gas stream outlet duct.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a perspective constructional view of an exemplary system for mixing a recirculated exhaust gas stream from a gas turbine with fresh air in a mixing chamber to obtain a gas mixture to be fed to a compressor of the gas turbine, according to a first embodiment;

FIG. 2 illustrates a simulation of the flow of an exhaust gas in a system with the same features of the system of FIG. 1, wherein no splitters are present; and

FIG. 3 illustrates a simulation of the flow of an exhaust gas in the system of FIG. 1, including two equally spaced splitters.

### DETAILED DESCRIPTION OF EMBODIMENTS

According to one aspect, the present subject matter is directed to systems for mixing a recirculated exhaust gas stream from a gas turbine with fresh air to obtain a gas mixture to be fed to a compressor of the gas turbine, the system including a mixing chamber and a recirculated exhaust gas stream inlet duct, a fresh air inlet duct and a mixed gas stream outlet duct, the recirculated exhaust gas stream inlet opening being in line with the mixed gas stream outlet opening and configured to define a linear path of the recirculated exhaust gas stream flowing inside the mixing chamber and the cross section of the recirculated exhaust gas stream inlet duct being calculated as a function of the recirculated exhaust gas stream flow rate and being configured to allow the velocity of the recirculated exhaust gas stream to be equal to the velocity of the mixed gas stream in the mixed gas stream outlet duct.

According to one aspect, the present subject matter is directed to systems for mixing a recirculated exhaust gas stream from a gas turbine with fresh air that is arranged downstream high-efficiency filters to prevent ingestion of CO₂ by ventilation fans from the exhaust gas.

According to another aspect, the present subject matter is directed to systems for mixing a recirculated exhaust gas stream from a gas turbine with fresh air to obtain a gas mixture to be fed to a compressor of the gas turbine wherein the recirculated exhaust gas stream inlet duct comprises a bent portion upstream the mixing chamber, wherein the bent portion comprises at least one splitter. In particular, according to an exemplary embodiment, the bent portion of the recirculated exhaust gas stream duct is 90° bent. Moreover, the bent portion of the recirculated exhaust gas stream duct is very close to a recirculated exhaust gas stream inlet opening of the mixing chamber, a straight portion of the recirculated exhaust gas stream duct being arranged between the bent portion and the recirculated exhaust gas stream inlet opening, the straight portion being shorter than the length of the bent radius of the concave side of the recirculated exhaust gas stream duct bent portion.

In another aspect, the subject matter disclosed herein concerns a system for mixing a recirculated exhaust gas stream from a gas turbine with fresh air which is configured to be arranged at an outlet end of a recirculated exhaust gas stream duct, downstream a EPA (efficient particulate air) filter group.

In yet another aspect, the subject matter disclosed herein concerns a system for mixing a recirculated exhaust gas stream from a gas turbine with fresh air wherein at least one splitter is arranged inside said recirculated exhaust gas stream duct bent portion, said splitter dividing the recirculated exhaust gas stream duct bent portion into bent sub-portions. In particular, two or more splitters can be arranged inside the recirculated exhaust gas stream duct bent portion, said splitters dividing the recirculated exhaust gas stream duct bent portion into three or more sub-portions. Conveniently, the splitters are equally distanced amongst each other.

In another aspect, the present subject matter is directed to systems for mixing a recirculated exhaust gas stream from a gas turbine with fresh air to obtain a gas mixture to be fed to a compressor of the gas turbine wherein the fresh air stream inlet opening is arranged symmetrically with respect to a symmetry plane dividing the mixing chamber into two halves, parallel to the recirculated exhaust gas stream flow direction. In particular, a porous filter can be arranged to cover said fresh air stream inlet opening.

In yet another aspect, the present subject matter is directed to systems for mixing a recirculated exhaust gas stream from a gas turbine with fresh air wherein the recirculated exhaust gas stream inlet duct is coaxial and concentric to the mixed gas stream outlet duct. In particular, the cross section of the recirculated exhaust gas stream duct and/or the cross section of the straight portion of the recirculated exhaust gas stream duct have the same shape, e.g. square or rectangular, and same or different size of the cross section of the mixed gas stream outlet duct.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

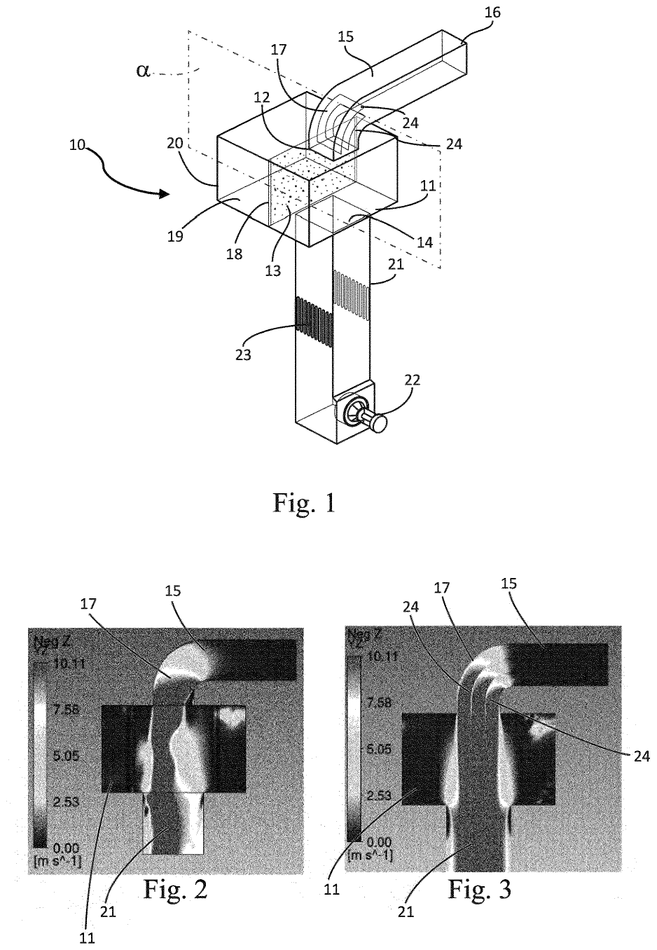

Referring now to the drawings, FIG. 1 shows a system 10 for mixing a recirculated exhaust gas stream with air to obtain a gas mixture to be fed to a gas turbine according to one embodiment of the present disclosure. The system 10 comprises a mixing chamber 11 configured to be connected to a recirculated exhaust gas stream line, downstream a filter group (not shown), and to a fresh air inlet line. In particular, the mixing chamber 11 is provided with a recirculated exhaust gas stream inlet opening 12, at the top of the mixing chamber 11, a fresh air stream inlet opening 13, at a lateral side 18 of the mixing chamber 11, and a mixed gas stream outlet opening 14, at the bottom of the mixing chamber 11 and in line with the recirculated exhaust gas stream inlet opening. The fresh air stream inlet opening 13 is provided with a porous filter, to remove any kind of impurities and to allow for a distribution of the flow of fresh air passing through the fresh air stream inlet opening 13 over the whole area of the fresh air stream inlet opening 13. In particular, the distribution of the flow of fresh air allows for a better mixing of fresh air with a recirculated exhaust gas stream coming from a recirculated exhaust gas stream duct 15, an end of said recirculated exhaust gas stream duct 15 being connected to the recirculated exhaust gas stream inlet opening 12 of the mixing chamber 11 to define a linear path of the recirculated exhaust gas stream flowing inside the mixing chamber 11 from the recirculated exhaust gas stream inlet opening 12 to the mixed gas stream outlet opening 14.

With continuing reference to FIG. 1, in an exemplary embodiment the recirculated exhaust gas stream duct 15 has a square cross section, with a side W, and comprises a bent portion 17, forming a sharp 90° bend, the ratio among the length of the bent radius R of the concave side of the recirculated exhaust gas stream duct bent portion 17 and the side W of the square cross section of the recirculated exhaust gas stream duct being:

$$R / W < 1$$

and the recirculated exhaust gas stream duct bent portion 17 being close to the recirculated exhaust gas stream inlet opening 12. Bending the recirculated exhaust gas stream duct 15 in proximity of the mixing chamber can be necessary due to available room constraints, but involves flow separation and flow fluctuation if it is not adequately counteracted.

In particular, in the exemplary embodiment of FIG. 1, two equally spaced splitters 24 are arranged inside the recirculated exhaust gas stream duct bent portion 17, said splitters being configured as bent sheets dividing the recirculated exhaust gas stream duct bent portion 17 into three bent sub-portions having the same cross section. It is intended that the number of splitters can vary, as well as their position inside the recirculated exhaust gas stream duct bent portion 17.

The fresh air stream is routed to the fresh air stream inlet opening 13 of the mixing chamber through a filter house 19, provided with a filter house inlet 20.

The mixed gas stream outlet opening 14, at the bottom of the mixing chamber 11, is connected to a first end of a mixed gas stream outlet duct 21, the second end of the mixed gas stream outlet duct 21 being provided with a gas turbine connector 22. A silencer 23 is also arranged along the mixed gas stream outlet duct 21. According to the exemplary embodiment of FIG. 1, the recirculated exhaust gas stream inlet duct 15 is coaxial and concentric to the mixed gas stream outlet duct 21.

In particular, given the flow rate of the mixed gas stream inside the mixed gas outlet duct 21, this parameter depending on the needs of the gas turbine to which the mixed gas stream is directed, then the velocity of the mixed gas stream inside the mixed gas stream outlet duct 21 is also given and is constant, this parameter depending on the flow rate and the cross section of the mixed gas stream outlet duct 21. In order to lower mixing loss (i.e. pressure loss), recirculation zones and vibrations of the system, the velocity of the recirculated exhaust gas stream entering the mixing chamber must be lower or equal to the velocity of the mixed gas stream inside the mixed gas stream outlet duct 21. This result is obtained by dimensioning the cross section of the recirculated exhaust gas stream inlet opening 12, which is equal to the cross section of the recirculated exhaust gas stream duct 15, the velocity of the recirculated exhaust gas in the recirculated exhaust gas stream duct 15 being equal to the ratio of the recirculated exhaust gas flow rate and the cross section of the recirculated exhaust gas stream duct 15. The amount of recirculated exhaust gas in the mixed gas stream is in turn dependent on the velocity of the recirculated exhaust gas in the recirculated exhaust gas stream duct 15. In particular, if the velocity of the mixed gas stream inside the mixed gas stream outlet duct 21 is equal to 10 m/s, then the velocity of the recirculated exhaust gas at the recirculated exhaust gas stream inlet opening 12 has to be equal to 10 m/s; therefore, given the exhaust gas recirculation ratio, expressed as a fraction of the flow rate of the mixed gas stream, the cross section of the recirculated exhaust gas stream duct 15 is calculated accordingly, as follows. In fact, the flow rate Mₘᵢₓ of the mixed gas stream inside the mixed gas outlet duct 21 can be expressed as a function of the density μₘᵢₓ and velocity vₘᵢₓ of the mixed gas stream and of the cross section Sₘᵢₓ of the mixed gas outlet duct 21:

$${M}_{mix} = {ρ}_{mix} \cdot {v}_{mix} \cdot {S}_{mix}$$

Correspondingly, the flow rate Mᵣ of the recirculated exhaust gas stream entering the mixing chamber 11 through the recirculated exhaust gas stream inlet opening 12 can be expressed as a function of the density ρᵣ and velocity vᵣ of the recirculated exhaust gas stream and of the cross section Sr of the recirculated exhaust gas stream inlet opening 12, while the flow rate Mₐ of the fresh air stream entering the mixing chamber 11 through the fresh air stream inlet opening 13 can be expressed as a function of the density ρₐ and velocity vₐ of the fresh air stream and of the cross section Sₐ of the fresh air stream inlet opening 13:

$${M}_{r} = {ρ}_{r} \cdot {v}_{r} \cdot {S}_{r}$$

$${M}_{a} = {ρ}_{a} \cdot {v}_{a} \cdot {S}_{a}$$

The flow rate Mₘᵢₓ of the mixed gas stream inside the mixed gas outlet duct 21 is also equal to the sum of the flow rate Mᵣ of the recirculated exhaust gas stream and the flow rate of fresh air Mₐ entering the mixing chamber 11:

$${M}_{mix} = {M}_{r} + {M}_{a}$$

Additionally, the flow rate Mᵣ of the recirculated exhaust gas stream can be expressed as a fraction x of the flow rate Mₘᵢₓ of the mixed gas stream and the flow rate of fresh air Mₐ can be expressed as a fraction (1−x) of the flow rate Mₘᵢₓ of the mixed gas stream:

$${M}_{r} = x \cdot {M}_{mix}$$

$${M}_{a} = ( 1 - x ) \cdot {M}_{mix}$$

It follows that

$${M}_{r} = {ρ}_{r} \cdot {v}_{r} \cdot {S}_{r} = x \cdot {M}_{mix} = x \cdot {ρ}_{mix} \cdot {v}_{mix} \cdot {S}_{mix}$$

Considering that, under the operative conditions of a subsonic compressor, ρᵣ and μₘᵢₓ can be considered equal, by imposing the design condition that vᵣ=vₘᵢₓ, the above relation can be written as follows:

$${M}_{r} = {ρ}_{mix} \cdot {v}_{mix} \cdot {S}_{mix} = x \cdot {M}_{mix} = x \cdot {ρ}_{mix} \cdot {v}_{mix} \cdot {S}_{mix}$$

from which follows

$${S}_{r} = x \cdot {S}_{mix}$$

Therefore, given the exhaust gas recirculation ratio, expressed as a fraction of the flow rate of the mixed gas stream, in order to allow the velocity of the recirculated exhaust gas at the recirculated exhaust gas stream inlet opening 12 to be equal to the velocity of the mixed gas stream inside the mixed gas stream outlet duct 21, then the cross section of the recirculated exhaust gas stream duct 15 is a same fraction of the cross section of mixed gas stream outlet duct 21.

The system for mixing a recirculated exhaust gas stream from a gas turbine with fresh air according to the present disclosure has been tested with different flow rates and has confirmed its validity for an ample range of exhaust gas recirculation ratio values, up to a maximum recirculated exhaust gas stream equal to 0.8 the mixed gas stream. The system according to the present disclosure has demonstrated to be valid also in case the exhaust gas recirculation percentage is regulated so as to allow the velocity of the recirculated exhaust gas at the recirculated exhaust gas stream inlet opening 12 to be from 70 to 130% the velocity of the mixed gas stream inside the mixed gas stream outlet duct 21. This is very important during transition phases, the velocity of the recirculated exhaust gas and the percentage of recirculated exhaust gas in the composition of the mixed gas stream being dependent on each other. As a consequence, in case the velocity of the recirculated exhaust gas decreases, the percentage of recirculated exhaust gas in the composition of the mixed gas stream is proportionally reduced, while the percentage of air is automatically increased due to the constant mixed gas flow that is sucked by the gas turbine.

With continuing reference to FIG. 1, FIG. 2 and FIG. 3 respectively illustrate a simulation of the flow of an exhaust gas in a system with the same features of the system of FIG. 1, but wherein no splitters are present, and in the system of FIG. 1. The figures show with different levels of darkness the velocity of the exhaust gas flow in the recirculated exhaust gas stream duct 15, inside the mixing chamber 11 and in the mixed gas stream outlet duct 21. The simulations show how the presence of the splitters 24 allows for a more homogeneous velocity of the gas flow and prevents flow separation and flow fluctuation (FIG. 3), which are still present in a splitter free system (FIG. 2).

While aspects of the invention have been described in terms of various specific embodiments, it will be apparent to those of ordinary skill in the art that many modifications, changes, and omissions are possible without departing form the spirt and scope of the claims.

1. A system for mixing a recirculated exhaust gas stream with air to obtain a gas mixture to be fed to a gas turbine, the flow ratio of the recirculated exhaust gas stream being a fraction of the flow ratio of the gas mixture to be fed to the gas turbine, the system comprising a mixing chamber, the mixing chamber being provided with: one recirculated exhaust gas stream inlet opening, on a first side of the mixing chamber, at least one fresh air stream inlet opening, on a second side of the mixing chamber, said second side being intersecting to said first side, and a mixed gas stream outlet opening, on a third side of the mixing chamber, said third side being opposed to said first side, the recirculated exhaust gas stream inlet opening being in line with the mixed gas stream outlet opening and configured to define a linear path of the recirculated exhaust gas stream flowing inside the mixing chamber from the recirculated exhaust gas stream inlet opening to the mixed gas stream outlet opening, wherein the recirculated exhaust gas stream inlet opening defines a recirculated exhaust gas stream inlet opening cross section and the mixed gas stream outlet opening defines a mixed gas stream outlet opening cross section, the recirculated exhaust gas stream inlet opening cross section being dimensioned as a fraction of the mixed gas stream outlet opening cross section, said fraction of the mixed gas stream outlet opening cross section being equal to from 70 to 130% the fraction of the flow ratio of the gas mixture to be fed to the gas turbine which is composed of recirculated exhaust gas.

2. The system of claim 1, wherein the cross section of said recirculated exhaust gas stream duct and of said recirculated exhaust gas stream inlet opening is configured to be equal to the fraction of the flow ratio of the gas mixture to be fed to the gas turbine which is composed of recirculated exhaust gas.

3. The system of claim 1, wherein said system is arranged downstream an EPA filter group.

4. The system of claim 1, wherein said third side of the mixing chamber is parallel to said first side.

5. The system of claim 1, wherein said first side and said second side of the mixing chamber are orthogonal.

6. The system of claim 1, wherein said recirculated exhaust gas stream duct comprises a bent portion and a straight portion, the straight portion being arranged between the bent portion and the recirculated exhaust gas stream inlet opening.

7. The system of claim 6, wherein said recirculated exhaust gas stream duct bent portion is 90° bent.

8. The system of claim 6, wherein the length of said straight portion arranged between the recirculated exhaust gas stream duct bent portion and the recirculated exhaust gas stream inlet opening is shorter than the length of the bent radius of the concave side of the recirculated exhaust gas stream duct bent portion.

9. The system of claim 6, wherein at least one splitter is arranged inside said recirculated exhaust gas stream duct bent portion, said splitter dividing the recirculated exhaust gas stream duct bent portion into bent sub-portions.

10. The system of claim 6, wherein two or more splitters are arranged inside said recirculated exhaust gas stream duct bent portion, said splitters dividing the recirculated exhaust gas stream duct bent portion into three or more sub-portions, with the same center of curvature as the recirculated exhaust gas stream duct bent portion.

11. The system of claim 10, wherein the two or more splitters are equally distanced amongst each other.

12. The system of claim 1, wherein said at least one fresh air stream inlet opening is arranged symmetrically with respect to a symmetry plane dividing the mixing chamber into two halves, parallel to the recirculated exhaust gas stream flow direction.

13. The system of claim 1, wherein a porous filter is arranged to cover said fresh air stream inlet opening.

14. The system of claim 13, wherein the porous filter is a EPA filter.

15. The system of claim 1, wherein recirculated exhaust gas stream inlet duct is coaxial and concentric to the mixed gas stream outlet duct.

16. The system of claim 1, wherein the cross section of said recirculated exhaust gas stream duct and/or the cross section of the straight portion of said recirculated exhaust gas stream duct and the cross section of said mixed gas stream outlet duct have the same shape.

17. The system of claim 1 wherein the cross section of said recirculated exhaust gas stream duct and/or the cross section of the straight portion of said recirculated exhaust gas stream duct and the cross section of said mixed gas stream outlet duct have a square or a rectangular section.

18. A method for mixing a recirculated exhaust gas stream with air to obtain a gas mixture to be fed to a gas turbine, the flow ratio of the recirculated exhaust gas stream being a fraction of the flow ratio of the gas mixture to be fed to the gas turbine, the method comprising the following steps: providing a system comprising a mixing chamber, the mixing chamber being provided with: one recirculated exhaust gas stream inlet opening, on a first side of the mixing chamber, at least one fresh air stream inlet opening, on a second side of the mixing chamber, said second side being intersecting to said first side, and a mixed gas stream outlet opening, on a third side of the mixing chamber, said third side being opposed to said first side, the recirculated exhaust gas stream inlet opening being in line with the mixed gas stream outlet opening and configured to define a linear path of the recirculated exhaust gas stream flowing inside the mixing chamber from the recirculated exhaust gas stream inlet opening to the mixed gas stream outlet opening, wherein the recirculated exhaust gas stream inlet opening defines a recirculated exhaust gas stream inlet opening cross section and the mixed gas stream outlet opening defines a mixed gas stream outlet opening cross section, the recirculated exhaust gas stream inlet opening cross section being dimensioned as a fraction of the mixed gas stream outlet opening cross section, said fraction of the mixed gas stream outlet opening cross section being equal to from 70% to 130% the fraction of the flow ratio of the gas mixture to be fed to the gas turbine which is composed of recirculated exhaust gas.

19. The method of claim 18, wherein the cross section of said recirculated exhaust gas stream duct and of said recirculated exhaust gas stream inlet opening is configured to be equal to the fraction of the flow ratio of the gas mixture to be fed to the gas turbine which is composed of recirculated exhaust gas.

20. The method of claim 18, wherein the exhaust gas recirculation ratio is varied in a range up to a maximum recirculated exhaust gas stream flow ratio equal to 0.8 the mixed gas stream flow ratio.

21. The method of claim 18, wherein, for each recirculated exhaust gas stream flow ratio, the velocity of the recirculated exhaust gas at the recirculated exhaust gas stream inlet opening is varied from 70 to 130% the velocity of the mixed gas stream inside the mixed gas stream outlet duct.
